(19) United States
(12) Patent Application Publication
(10) Pub. No.: US 2008/0225950 A1
(43) Pub. Date: Sep. 18, 2008

(54) Scalable architecture for video codecs

(75) Inventor: Xiaohan Zhu, Alviso, CA (US)

Correspondence Address: Trellis Intellectual Property Law Group, PC, 1900 EMBARCADERO ROAD, SUITE 109, PALO ALTO, CA, 94303, US

(73) Assignees: Sony Corporation, Tokyo (JP); Sony Electronics Inc., Park Ridge, NJ (US)

(21) Appl. No.: 11/717,949

(22) Filed: Mar. 13, 2007

(51) Int. Cl. H04N 11/02

(52) U.S. Cl. 375/240.14; 375/E07.015

(57) ABSTRACT

In one embodiment, a method for parallel processing of blocks in a decoding process is provided. A plurality of blocks for a picture is received. The picture may have the plurality of blocks arranged in a first order. The blocks in the plurality of blocks may be pre-processed to determine data dependency information for blocks. In one embodiment, the blocks in the picture are all pre-processed to determine the data dependency information for every block in the picture if possible. Blocks that do not have data dependencies are then determined and sent for parallel processing in processing units. Also, blocks that still have data dependencies are not processed until the data dependency information becomes available. For example, an inter-coded block may be decoded and information for the decoded block is used to decode the intra-coded block. At this point, these blocks may be sent for processing in the processing units.

### BACKGROUND

Particular embodiments generally relate to transcoding.

In a video decoder, a picture or frame may be decoded in a video sequence of a number of pictures. The picture may be broken up into a number of macroblocks, which include a portion of the picture. Because there are data dependencies among adjacent macroblocks, the decoder has to decode macroblock by macroblock in a sequential raster scan order. Accordingly, the time required to decode one picture is the sum of the time to decode each macroblock in the picture. For larger size pictures, it is challenging to finish the decoding of the entire picture within the required timeframe.

### SUMMARY

In one embodiment, a method for parallel processing of blocks in a decoding process is provided. A plurality of blocks for a picture is received. The picture may have the plurality of blocks arranged in a first order. The blocks in the plurality of blocks may be pre-processed to determine data dependency information for blocks. In one embodiment, the blocks in the picture are all pre-processed to determine the data dependency information for every block in the picture if possible. For example, it may be determined whether a macroblock is intra-coded or inter-coded. Further, the data dependency information may be determined such that whichever data dependencies that can be removed during pre-processing are removed. However, some blocks may not be able to have data dependencies removed. For example, intra-coded blocks may depend on the decoded results of adjacent blocks. Blocks that do not have data dependencies are then determined and sent for parallel processing in processing units. Also, blocks that still have data dependencies are not processed until the data dependency information becomes available. For example, an inter-coded block may be decoded and information for the decoded block is used to decode the intra-coded block. At this point, these blocks may be sent for processing in the processing units. Accordingly, the blocks may be processed in parallel when data dependencies do not exist. This provides faster processing of blocks in a picture than if a sequential processing of the blocks in the first order is performed.

A further understanding of the nature and the advantages of particular embodiments disclosed herein may be realized by reference of the remaining portions of the specification and the attached drawings.

### BRIEF DESCRIPTION OF THE DRAWINGS

FIG. 1 depicts an example of a decoder according to one embodiment of the present invention.

FIG. 2 shows an example of a processing unit.

FIG. 3 shows an example of a picture according to one embodiment.

FIG. 4 shows an example of stages that can be scheduled by a scheduler using the picture depicted in FIG. 3

FIG. 5 depicts a simplified flowchart of a method for performing decoding.

### DETAILED DESCRIPTION OF EMBODIMENTS

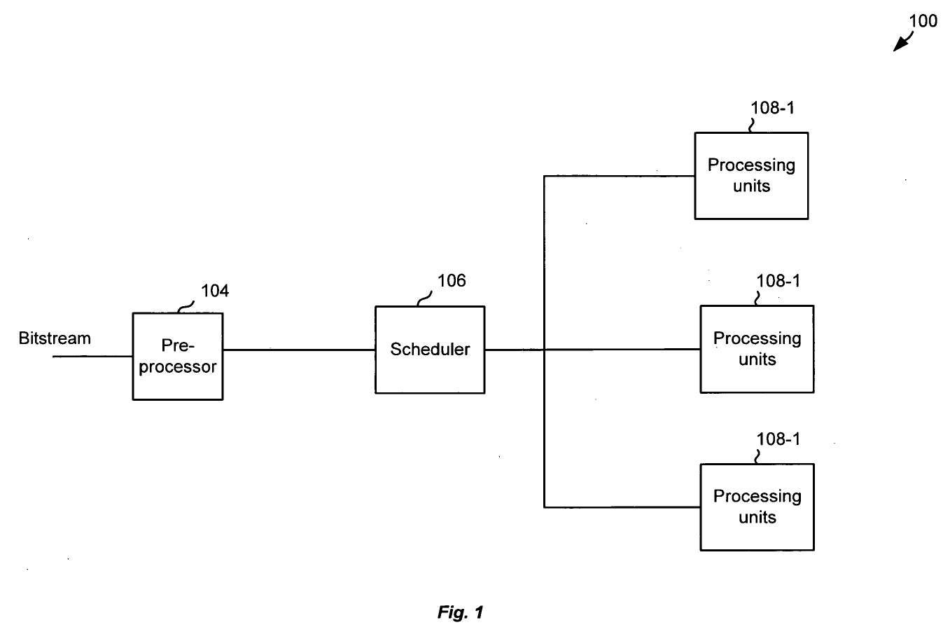

FIG. 1 depicts an example of a decoder 100 according to one embodiment of the present invention. As shown, a pre-processor 104, a scheduler 106, and a plurality of processing units 108 are provided.

Pre-processor 104 is configured to pre-process data received in a bit stream. In one example, pre-processor 104 includes a variable length decoder (VLD) that can decode the bit stream.

A video sequence may include a series of pictures or frames. These pictures may be broken into blocks, which may be referred to as macroblocks. The macroblocks are 16×16 but may be composed of variable sized blocks of any size, such as 4×4, 8×8, etc. In one embodiment, pre-processor 104 pre-processes all of the blocks for a picture. This may be different from pre-processing blocks in a sequential order (e.g., raster scan order) and then sending them to a decoder without pre-processing all the blocks of the picture. In this case, data dependencies for the whole picture may be removed based on the pre-processing. For example, pre-processor 104 generates a bit map of all the blocks in a picture indicating whether a block is intra-coded or inter-coded. Inter-coded blocks have data dependencies on other pictures or frames. Intra-coded blocks have data dependencies on the decoded results of adjacent blocks in the picture. The bit map may be later used to determine which blocks to schedule.

Pre-processor 104 may perform entropy decoding by receiving a bit stream and outputting image data and motion vectors. The image data may be in the form of transform coefficients. The motion vector may be used to determine the motion compensation for a block.

Pre-processor 104 may determine all motion vectors for blocks during the pre-processing. When the motion vectors are determined, inter-coded blocks no longer have data dependencies to other blocks in the same picture. Accordingly, inter-blocks may be dispatched to processing units whenever possible because they do not have any other data dependencies to blocks in the picture. That is, all the data dependency information for a block is known after pre-processing and thus the blocks can be processed in any order.

Intra-coded blocks may still have data dependencies to the decoded results of the adjacent blocks and therefore have to wait until the data dependency information is available. For example, adjacent blocks may need to be decoded before an intra-coded block because decoded information from the decoded blocks is needed to decode the intra-coded block. When this information is available, the intra-coded block can be dispatched to processing unit 108 and is decoded with the dependency information.

Scheduler 106 is configured to schedule blocks for processing in processing units 108. Scheduler 106 may schedule blocks in parallel when blocks do not have data dependencies on other blocks. However, if data dependencies exist, scheduler 106 waits until the data is known, and then dispatches the block for processing. Scheduler 106 may analyze the bit map of the preprocessed picture to determine which blocks can be dispatched for processing. For example, as many inter-coded blocks may be dispatched for processing as possible. However, scheduler 106 may consider which blocks can be dispatched for decoding such that data dependencies for intra-coded blocks may be alleviated. For example, a block that needs to be decoded to determine data dependency information may be dispatched before another inter-coded block that is ready to be decoded.

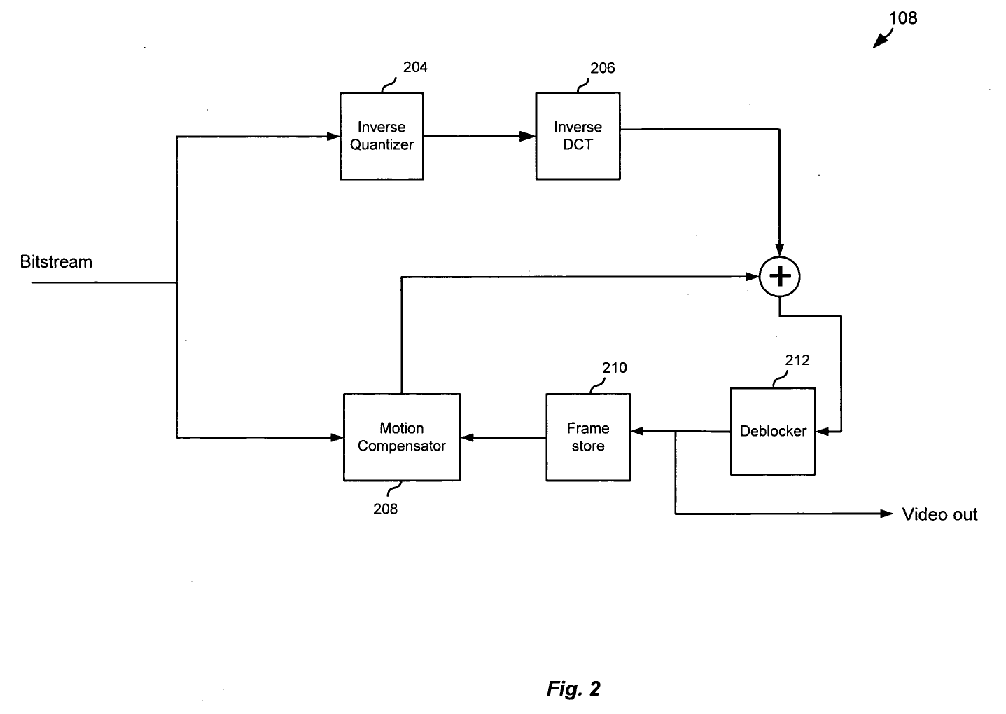

Processing units 108 may include units that are configured to decode blocks. FIG. 2 shows an example of processing unit 108. As shown, processing unit 108 may include an inverse quantitizer 204, an inverse discrete cosine transform (DCT) module 206, a motion compensator 208, a frame store 210, and a deblocker 212.

Inverse quantitizer 204 is configured to perform an inverse quantitization. Inverse DCT module 206 is configured to perform an inverse DCT operation. The output of these stages provides a compressed picture/prediction error.

Motion compensator 208 is configured to determine the motion compensation for a block. Motion compensation uses the motion vectors to load a corresponding area in the reference picture, interpolate these reference pixels and add them to the output from inverse DCT module 206. The outputs of motion compensator 208 and inverse DCT module 206 are combined to determine a decoded block.

Frame store 210 is configured to store decoded blocks for use in determining the motion compensation for other blocks.

Deblocker 212 is then configured to reduce blocking distortion. The block edges may be smoothed improving the appearance of the decoded blocks.

A person skilled in the art will appreciate how decoder 102 works.

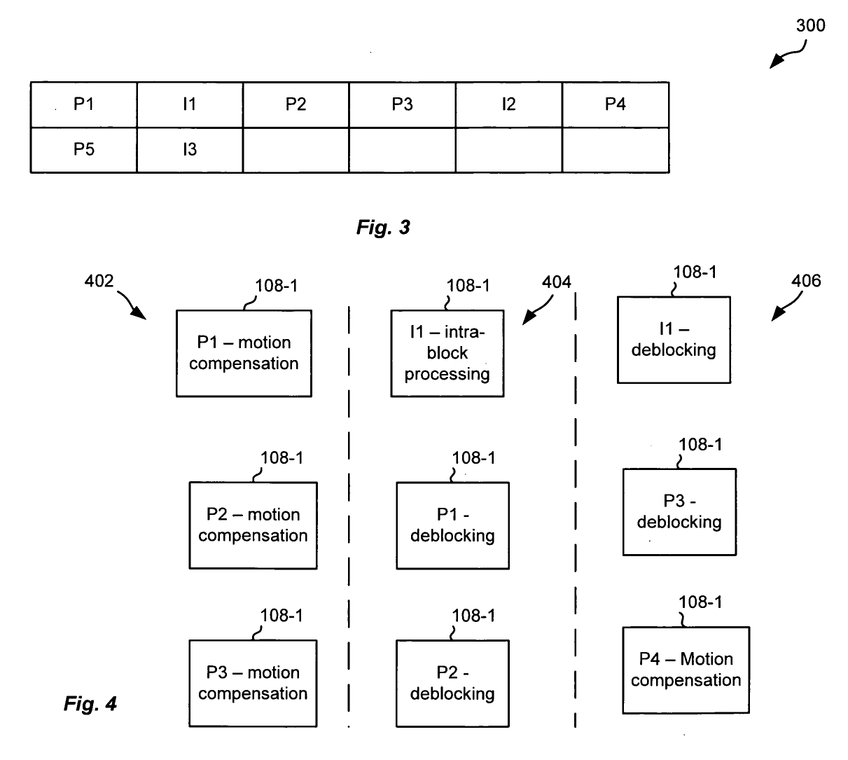

FIG. 3 shows an example of a picture 300 according to one embodiment. As shown, intra-coded blocks are designated with the letter “I” and inter-coded blocks may be P or B pictures designated by a “P” or “B”. Because the inter-coded blocks do not have data dependencies in the picture, these may be dispatched in parallel. Scheduler 106 uses information from the pre-processor 104 to dispatch blocks to processing units 108 without violating data dependencies. In one example, the blocks P1, P2, and P3 may be assigned to processing units 108 in parallel. These blocks are then decoded.

Scheduler 106 may dispatch block I1 after P1 has been decoded. This is because I1 is an intra-coded block and may depend on the decoded pixels of P1. Also, in the next stage, another processing unit 108 may be assigned for de-blocking for P1. Further, when P2 and P3 are decoded, they may be assigned for de-blocking. Other operations may also be performed. For example, the IQ and IDCT calculations may be performed at any time because these operations do not have data dependencies on other blocks. These calculations may be assigned to processing units 108 when the operations need to be performed for the blocks.

Accordingly, data dependencies are removed in a pre-processing step. After the pre-processing step, computationally-intensive computations may be performed in parallel thus speeding up the whole processing speed of each picture. For example, computational intensive inter-coded motion compensation may be performed in parallel. This allows a video codec design to scale up to be able to handle a large picture size because more blocks can be processed in the amount of time required for a picture.

FIG. 4 shows an example of stages that can be scheduled by scheduler 106 using the picture depicted in FIG. 3. Scheduler 106 may schedule blocks for processing in processing units 108 when all required data for decoding is available. In one embodiment, the P blocks are processed in a first stage 402 in processing units 108. Processing units 108 may perform the motion compensation for the inter-coded blocks.

In a second stage 404, when P1 has been decoded, the block I1 can be dispatched to a processing unit 108 for intra-block processing. For example, intra-block intra-prediction may be performed. Also, the other decoded inter-blocks may be sent for de-blocking in processing units 108. For example, blocks P1 and P2 may be sent for de-blocking.

In the third stage 406, the block P3 may be sent for de-blocking in addition to the intra-block I1. Another inter-block, P4 may also be processed by a processing unit 108. Accordingly, blocks that do not have data dependencies being processed in parallel and then when data dependencies are alleviated for other blocks, these blocks may also be processed.

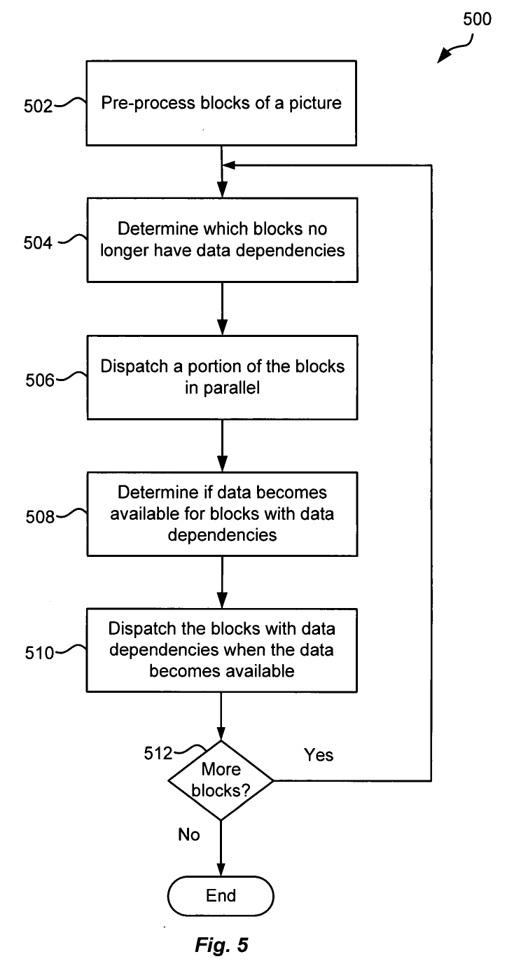

FIG. 5 depicts a simplified flowchart 500 of a method for performing decoding. Step 502 pre-processes blocks of a picture. For example, pre-processing determines any data dependencies that are possible for blocks in an entire picture. This is so scheduler 106 can determine when blocks can be dispatched to processing units 108 in parallel.

Step 504 determines which blocks no longer have data dependencies. For example, all inter-blocks may not have any data dependencies within the picture and thus can be processed at any time. However, scheduler 106 may select blocks in which other blocks are dependent on for processing first.

Step 506 dispatches a portion of the blocks in parallel. For example, if inter-blocks are found in the picture, they may be dispatched for processing. However, blocks that may have data dependencies are not dispatched until the data that is needed is determined.

Step 508 determines if data becomes available for blocks with data dependencies. For example, for intra-blocks, adjacent blocks may have to be decoded before the intra-block can be decoded.

Step 510 dispatches the blocks with data dependencies when the data becomes available. Accordingly, blocks without data dependencies may be processed in parallel; in addition, when blocks with data dependencies have their data dependencies alleviated, they may be sent for processing also. Scheduler 106 uses the pre-processing of a picture to determine how to schedule the blocks in the picture. Because the blocks may be pre-processed all at once, this allows scheduler 106 to dispatch blocks as soon as possible without violating data dependencies.

Step 512 then determines if there are more blocks to process. If so, the process reiterates to step 504 where it is determined which blocks no longer have data dependencies. If there are no more blocks in the picture, the process may end or decode the next picture.

In one embodiment, instead of having a global scheduler, processing units 108 may make decisions on which blocks to process. Processing units 108 may use shared memory to store a table indicating which blocks have been scheduled or decoded and whether a block is intra-coded or inter-coded. Processing units 108 could decide which block to process according to this table. Thus, scheduler 106 may not be needed to schedule blocks for processing units 108.

In summary, particular embodiments provide many advantages. For example, because processing can be distributed to multiple processing units, blocks of a picture may be processed quicker. Pre-processing is performed to determine data dependency information for blocks such that they can be dispatched in parallel. Data dependencies are removed in a less intensive pre-processing step. Thus, more computationally-intensive processing may be performed in parallel later. This speeds up overall processing of blocks. Further, this allows the video codec design to scale to be able to handle a larger picture size. This is because computationally intensive tasks can be performed in parallel.

Although the description has been described with respect to particular embodiments thereof, these particular embodiments are merely illustrative, and not restrictive. Although H.264 is discussed, it will be understood that other coding standards may be used with particular embodiments.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing. Functions can be performed in hardware, software, or a combination of both. Unless otherwise stated, functions may also be performed manually, in whole or in part.

In the description herein, numerous specific details are provided, such as examples of components and/or methods, to provide a thorough understanding of particular embodiments. One skilled in the relevant art will recognize, however, that a particular embodiment can be practiced without one or more of the specific details, or with other apparatus, systems, assemblies, methods, components, materials, parts, and/or the like. In other instances, well-known structures, materials, or operations are not specifically shown or described in detail to avoid obscuring aspects of particular embodiments.

A “computer-readable medium” for purposes of particular embodiments may be any medium that can contain, store, communicate, propagate, or transport the program for use by or in connection with the instruction execution system, apparatus, system, or device. The computer readable medium can be, by way of example only but not by limitation, an electronic, magnetic, optical, electromagnetic, infrared, or semiconductor system, apparatus, system, device, propagation medium, or computer memory.

Particular embodiments can be implemented in the form of control logic in software or hardware or a combination of both. The control logic, when executed by one or more processors, may be operable to perform that what is described in particular embodiments.

A “processor” or “process” includes any human, hardware and/or software system, mechanism or component that processes data, signals, or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, “a specific embodiment”, or “particular embodiment” means that a particular feature, structure, or characteristic described in connection with the particular embodiment is included in at least one embodiment and not necessarily in all particular embodiments. Thus, respective appearances of the phrases “in a particular embodiment”, “in an embodiment”, or “in a specific embodiment” in various places throughout this specification are not necessarily referring to the same embodiment. Furthermore, the particular features, structures, or characteristics of any specific embodiment may be combined in any suitable manner with one or more other particular embodiments. It is to be understood that other variations and modifications of the particular embodiments described and illustrated herein are possible in light of the teachings herein and are to be considered as part of the spirit and scope.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated particular embodiments, including what is described in the Abstract, is not intended to be exhaustive or to limit the invention to the precise forms disclosed herein. While specific particular embodiments of, and examples for, the invention are described herein for illustrative purposes only, various equivalent modifications are possible within the spirit and scope, as those skilled in the relevant art will recognize and appreciate. As indicated, these modifications may be made to the present invention in light of the foregoing description of illustrated particular embodiments and are to be included within the spirit and scope.

Thus, while the present invention has been described herein with reference to particular embodiments thereof, a latitude of modification, various changes and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit. It is intended that the invention not be limited to the particular terms used in following claims and/or to the particular embodiment disclosed as the best mode contemplated for carrying out this invention, but that the invention will include any and all particular embodiments and equivalents falling within the scope of the appended claims.

We claim:

1. A method for parallel processing of blocks in a decoding process, the method comprising:
receiving a plurality of blocks for a picture, the plurality of blocks arranged in a first order in the picture, wherein blocks in the plurality of blocks include data dependencies;
preprocessing blocks in the plurality of blocks for the picture to determine data dependency information for the blocks to remove their data dependencies; and
scheduling blocks in the plurality of blocks for processing in processing units in parallel, wherein a block is scheduled when data dependency information is available for the block, wherein blocks in the plurality of blocks are processed in a second order different from the first order.

2. The method of claim 1, wherein the preprocessing comprises processing all of the blocks for the picture to determine the data dependency information for the picture.

3. The method of claim 2, wherein the preprocessing comprises determining which blocks in the picture are inter-coded and intra-coded.

4. The method of claim 3, wherein scheduling blocks in the plurality of blocks comprises using which blocks are inter-coded and intra-coded to determine which blocks do not have data dependencies.

5. The method of claim 1, wherein when a block has a data dependency that is not removed during pre-processing, the method further comprising:
determining when information for the data dependency is available; and
sending the block to a processing unit when the information is available.

6. The method of claim 1, further comprising:
determining one or more blocks in the plurality of blocks in which a block has a data dependency; and
scheduling the one or more blocks for processing to determine data dependency information for the block.

7. The method of claim 6, further comprising scheduling the block for processing upon determining the data dependency information for the block.

8. The method of claim 1, wherein the processing comprises motion compensation for inter-blocks.

9. The method of claim 1, wherein the processing comprises intra prediction for intra-blocks.

10. An apparatus configured to parallel process blocks in a decoding process, the apparatus comprising:
one or more processors; and
logic encoded in one or more tangible media for execution by the one or more processors and when executed operable to:
receive a plurality of blocks for a picture, the plurality of blocks arranged in a first order in the picture, wherein blocks in the plurality of blocks include data dependencies;
preprocess blocks in the plurality of blocks for the picture to determine data dependency information for the blocks to remove their data dependencies; and
schedule blocks in the plurality of blocks for processing in processing units in parallel, wherein a block is scheduled when data dependency information is available for the block, wherein blocks in the plurality of blocks are processed in a second order different from the first order.

11. The apparatus of claim 10, wherein the logic when executed is further operable to process all of the blocks for the picture to determine the data dependency information for the picture.

12. The apparatus of claim 11, wherein the logic when executed is further operable to determine which blocks in the picture are inter-coded and intra-coded.

13. The apparatus of claim 12, wherein the logic when executed is further operable to use which blocks are inter-coded and intra-coded to determine which blocks do not have data dependencies.

14. The apparatus of claim 10, wherein when a block has a data dependency that is not removed during pre-processing, wherein the logic when executed is further operable to:
determine when information for the data dependency is available; and
send the block to a processing unit when the information is available.

15. The apparatus of claim 10, wherein the logic when executed is further operable to:
determine one or more blocks in the plurality of blocks in which a block has a data dependency; and
schedule the one or more blocks for processing to determine data dependency information for the block.

16. The apparatus of claim 15, wherein the logic when executed is further operable to schedule the block for processing upon determining the data dependency information for the block.

17. The apparatus of claim 10, wherein the processing comprises motion compensation for inter-blocks.

18. The apparatus of claim 10, wherein the processing comprises intra prediction for intra-blocks.

19. An apparatus configured to provide parallel processing of blocks in a decoding process, the apparatus comprising:
means for receiving a plurality of blocks for a picture, the plurality of blocks arranged in a first order in the picture, wherein blocks in the plurality of blocks include data dependencies;
means for preprocessing blocks in the plurality of blocks for the picture to determine data dependency information for the blocks to remove their data dependencies; and
means for scheduling blocks in the plurality of blocks for processing in processing units in parallel, wherein a block is scheduled when data dependency information is available for the block, wherein blocks in the plurality of blocks are processed in a second order different from the first order.
